(19) United States
(12) Patent Application Publication
(10) Pub. No.: US 2009/0018965 A1
(43) Pub. Date: Jan. 15, 2009

(54) ECOMMERCE PRICE MATCH SYSTEM

(76) Inventor: Ben Neydavood, Los Angeles, CA (US)

Correspondence Address: Patent Venture Group, 10788 Civic Center Drive, Suite 215, Rancho Cucamonga, CA, 91730-3805, US

(21) Appl. No.: 11/969,892

(22) Filed: Jan. 5, 2008

Related U.S. Application Data
(60) Provisional application No. 60/883,551, filed on Jan. 5, 2007.

(51) Int. Cl. H04L 9/00; G06Q 30/00

(52) U.S. Cl. 705/80; 705/26

(57) ABSTRACT

A system for a customer to obtain price matching from a vendor in an ecommerce transaction. A first browser screen is presented to the customer offering a product of the vendor. This includes information about the product, with an offer price, and a price match request control that the customer may operate. Upon operation of the price match request control, a second browser screen is presented that includes a price match dialog form. This includes a price entry control for the customer to enter counter price data and a competitor entry control for the customer to enter competing vendor data. The counter price data and competing vendor data are analyzed for acceptability of the ecommerce transaction. If the vendor accepts the ecommerce transaction, a third browser screen is presented that includes an unit price having the counter price data entered by the customer.

### CROSS-REFERENCE TO RELATED APPLICATIONS

This application claims the benefit of U.S. Provisional Application No. 60/883,551, filed Jan. 5, 2007.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### TECHNICAL FIELD

The present invention relates generally to data processing including cost/price determination, and more particularly to electronic negotiation including an offer and acceptance or counteroffer among parties.

### BACKGROUND ART

Global communications networks, such as the present Internet, are changing many aspects of our daily lives. Modern e-commerce is an example. Using a web browser and the Internet one can now often determine whether a retailer carries a particular merchandise item. In fact, this is usually done more quickly and accurately than by using traditional methods like telephoning or visiting a retail outlet and asking a clerk. Furthermore, again using a web browser and the Internet, today one can usually find a number of retailers carrying a particular item of interest; determine which of these retailers currently have the item in stock; compare their pricing for the item (including incidental costs like taxes, shipping, and pricing for desired accessories); purchase the item; and, in the case of some items like music, videos, books, and computer software, even take online delivery of one's purchases.

In many respects e-commerce today employs older, traditional retail metaphors. Thus, to shop we go to an online virtual store; to select something we are likely to purchase we put it in a virtual shopping cart; and to consummate a purchase transaction we proceed to a virtual checkout section of the virtual store. And other e-commerce examples abound. For instance, we can visit online auction cites that function in many respects like traditional auctions have since the beginning of recorded history. Reserve prices and different bidding protocols can be set by the auctioneers, and we can employ long common bidding approaches as prospective auctionees.

Unfortunately, with all of the successes that e-commerce now enjoys, there remain ways in which it has yet to provide the same benefits that older “brick and mortar” type retailers can. For example, traditional retailers often advertise and honor a “we match any advertised price” policy. A consumer then might see an advertisement in a newspaper, or even on the Internet, that Alpha Stores is selling model XYZ microwave ovens for $219.95 and Beta Stores is selling the same model XYZ microwave ovens for $199.95. If our hypothetical consumer knows that Alpha Stores has a price matching policy, or if he or she even suspects that this retailer might be “flexible,” our consumer can go to an Alpha Store outlet, show the manager a copy of the Beta Stores advertisement, and ask to buy a XYZ microwave oven for $199.95. Until the advent of the present invention, such a scenario has not been possible in an e-commerce context.

### BRIEF SUMMARY OF THE INVENTION

Accordingly, it is an object of the present invention to provide a price matching system that is particularly suitable for use in e-commerce.

Briefly, one preferred embodiment of the present invention is a computer program, embodied on a computer readable storage medium, for a customer to obtain price matching from a vendor in an ecommerce transaction. A code segment presents a first browser screen to the customer offering a product of the vendor. This first browser screen includes information about a product that further includes an offer price and a price match request control that the customer may selectively operate. Another code segment then presents a second browser screen. This second browser screen includes a price match dialog form that further includes a price entry control for the customer to enter counter price data, a competitor entry control for the customer to enter competing vendor data, and a web site navigation control that the customer may selectively operate. Another code segment then performs an analysis of the counter price data and competing vendor data to determine acceptability of the ecommerce transaction, and presents a third browser screen that includes an unit price that displays the counter price data entered by the customer if the vendor is accepting the ecommerce transaction.

Briefly, another preferred embodiment of the present invention is a method for a customer to obtain price matching from a vendor in an ecommerce transaction. A first browser screen is presented to the customer, offering a product of the vendor. This first browser screen provides information about a product, that further includes an offer price, and includes a price match request control that the customer may selectively operate. Responsive to operation of said price match request control, a second browser screen is presented. This second browser screen includes a price match dialog form that has a price entry control for the customer to enter counter price data and a competitor entry control for the customer to enter competing vendor data. This second browser screen includes also provides a web site navigation control that the customer may selectively operate. Responsive to operation of said web site navigation control by, said counter price data and said competing vendor data are analyzed for acceptability of the ecommerce transaction. If the vendor accepts the ecommerce transaction, a third browser screen is then presented that includes an unit price that displays said counter price data entered by the customer.

Briefly, another preferred embodiment of the present invention is a system for a customer to obtain price matching from a vendor in an ecommerce transaction. A means for presenting a first browser screen to the customer offers a product of the vendor. This first browser screen includes information about the product, further including an offer price, and a price match request control that the customer may selectively operate. A means for monitoring for operation of said price match request control then engages a means for presenting a second browser screen that includes a price match dialog form. This price match dialog form includes a price entry control for the customer to enter counter price data and a competitor entry control for the customer to enter competing vendor data. Further included in the system is a means for analyzing said counter price data and said competing vendor data for acceptability of the ecommerce transaction. And further included in the system is a means for presenting a third browser screen that includes an unit price having said counter price data entered by the customer if the vendor accepts the ecommerce transaction.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1 shows a first browser screen in accord with the present inventive price matching system;

FIG. 2 shows a second browser screen, reachable from the browser screen in FIG. 1;

FIG. 3 shows a third browser screen including details based on a traditional transaction merely in accord with the conventional features in the browser screen in FIG. 1;

FIG. 4 shows the third browser screen including details based on a new form of transaction in accord with the invention-related features enabled in the first or second browser screens in FIGS. 1 and 2;

And FIG. 5 is a flow chart showing a price matching process in accord with the present invention.

In the various figures of the drawings, like references are used to denote like or similar elements or steps.

### DETAILED DESCRIPTION OF THE INVENTION

A preferred embodiment of the present invention is a price matching system that is particularly suitable for use in e-commerce. As illustrated in the various drawings herein, preferred embodiments of the invention are depicted by the general reference character 10.

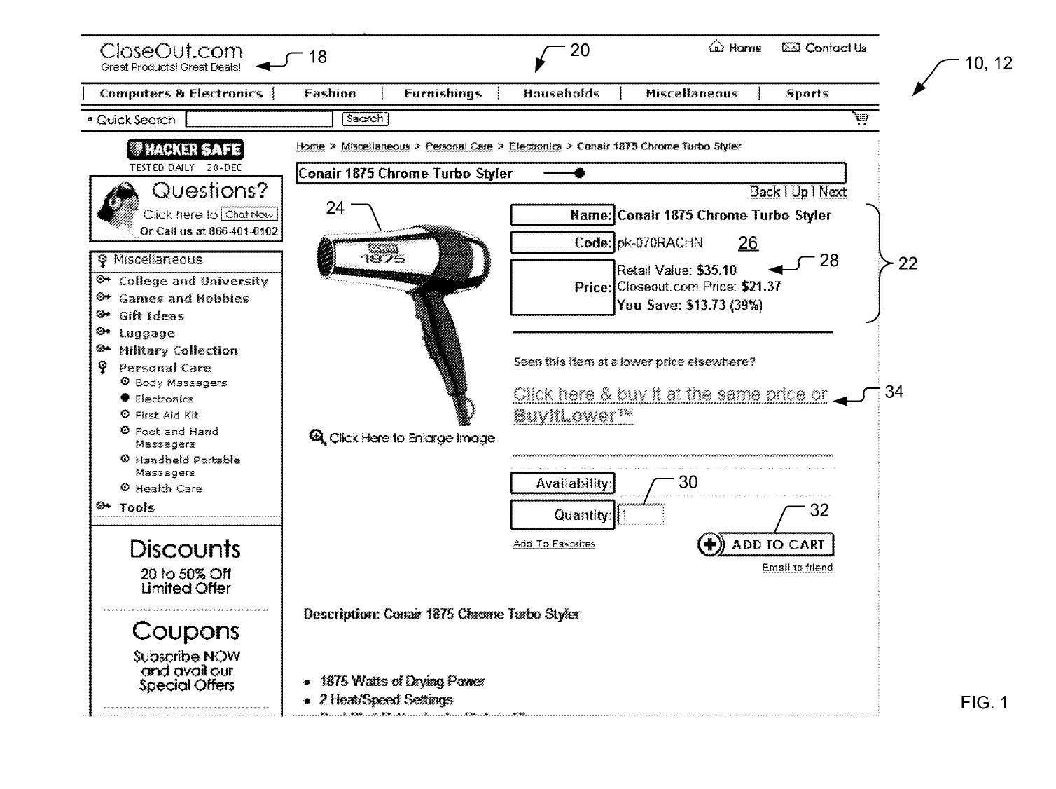

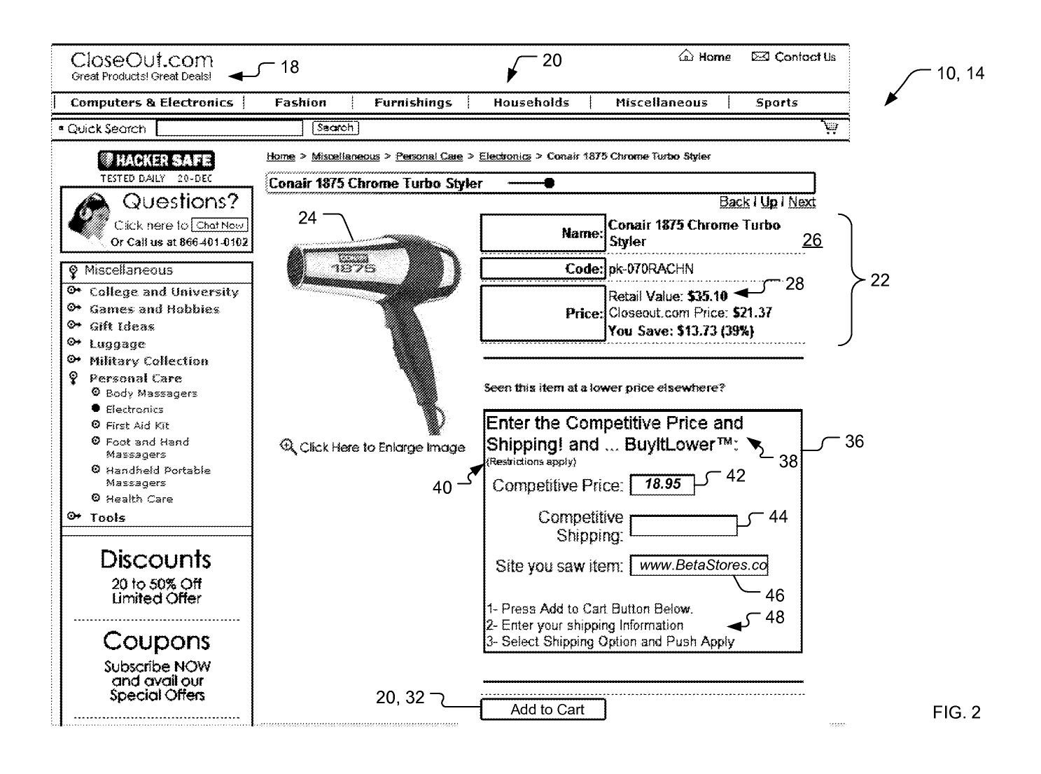

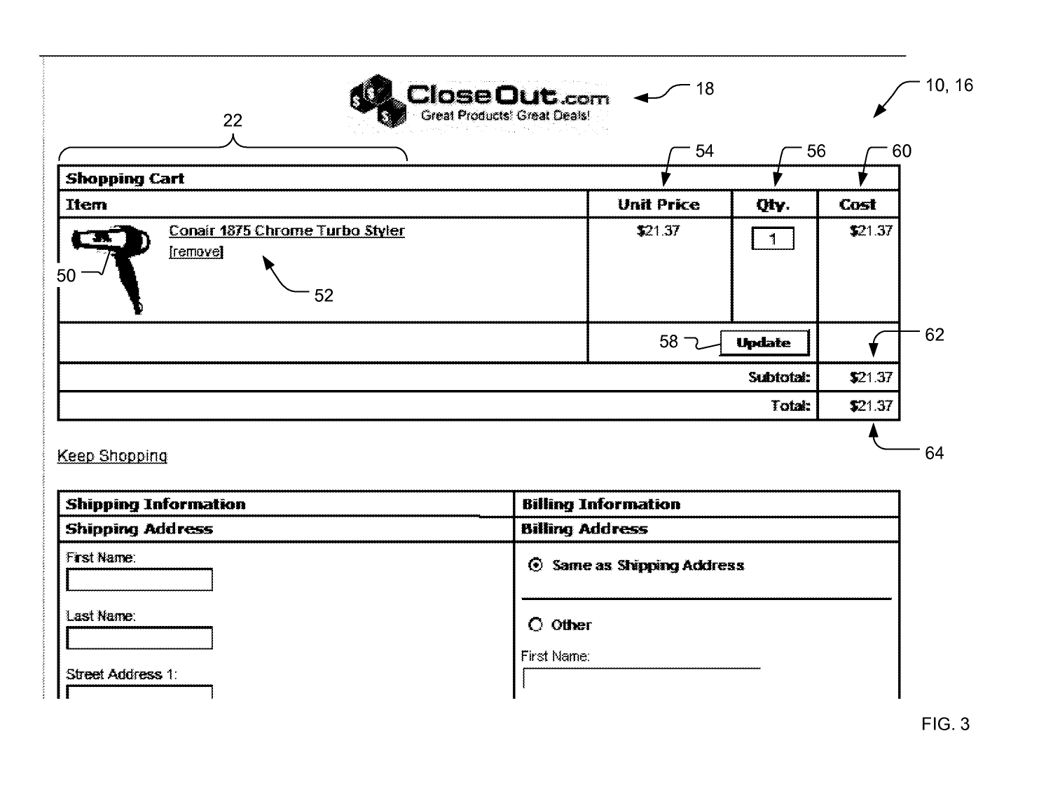

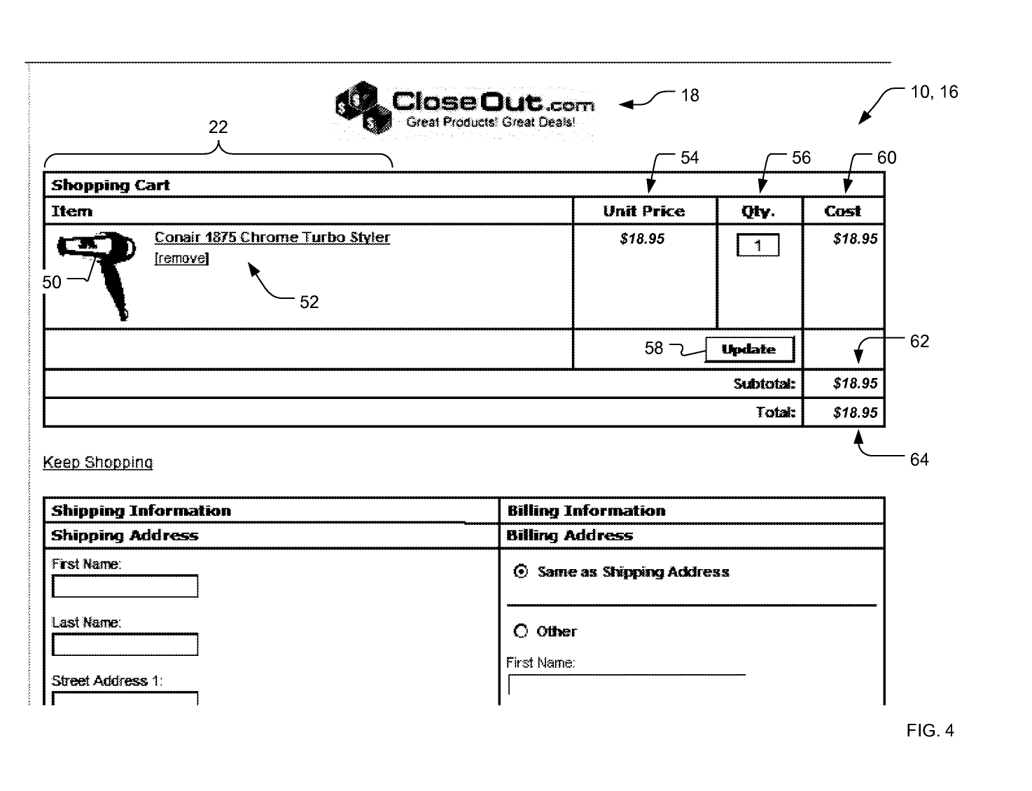

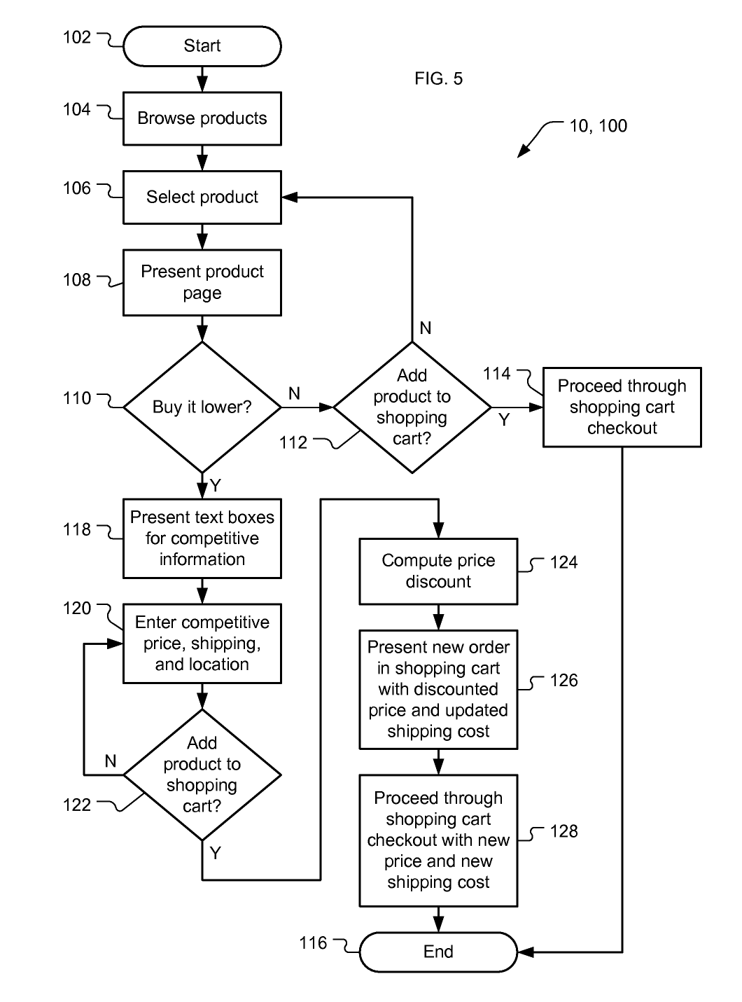

FIG. 1 shows a first browser screen 12 in accord with the present inventive price matching system 10. FIG. 2 shows a second browser screen 14, reachable from the browser screen 12 in FIG. 1. And FIGS. 3 and 4 show a third browser screen 16, reachable from the first or second browser screens 12,14 in FIG. 1 or 2, wherein FIG. 3 includes details based on a traditional transaction merely in accord with the conventional features in the browser screen 12 in FIG. 1 and FIG. 4 includes details based on a new form of transaction in accord with the invention-related features enabled in the first or second browser screens 12,14 in FIGS. 1 and 2. Turning now to FIG. 1, the browser screen 12 here includes many essentially conventional e-commerce retailing features. For example, it includes vendor identification information 18; web site navigation controls 20; and information about a product 22 that is being offered, including a picture 24, a description 26, and an offer price 28. The product 22 may be a conventional physical, tangible product, e.g., a hair dryer as shown in the example in the figures, or it may it may be essentially anything that can be sold in e-commerce retailing. Thus, some additional examples, without limitation are: downloadable e-books, music, and videos; units of physical labor and professional services; and virtual units of these for use in virtual worlds (e.g., in Second Life™). Continuing, the browser screen 12 here also includes a Quantity control 30 and an Add To Cart control 32 (i.e., a specific type of web site navigation controls 20).

In an entirely conventional manner, a visitor to the browser screen 12 here in FIG. 1 could simply operate the Add To Cart control 32, accepting the default in the Quantity control 30, and proceed to the browser screen 16 as shown in FIG. 3.

The one particularly novel feature in the browser screen 12 in FIG. 1 is a price match request control 34. If a user of the browser screen 12 operates this they are taken to the browser screen 14 in FIG. 2.

The browser screen 14 in FIG. 2 includes most of the very same conventional features found in FIG. 1. Additionally, however, the browser screen 14 includes a price match dialog form 36 that includes initial instructions 38, a link to restrictions 40, a price entry control 42, a shipping entry control 44, a competitor entry control 46, and concluding instructions 48. Representative data, which will be discussed presently, is shown entered in the price entry control 42 and the competitor entry control 46 here.

By following the initial instructions 38 a user can enter a competitor's price for the subject product 22 in the price entry control 42 and enter identifying information about the web site of this competitor in the competitor entry control 46. Optionally, the user can also enter a shipping cost in the shipping entry control 44. Then, by following the concluding instructions 48, the user operates the Add To Cart control 32 and is taken to the browser screen 16 as shown in FIG. 4.

The browser screen 16 in FIGS. 3 and 4 also includes conventional e-commerce retailing features. It again has the vendor identification information 18 and information related to purchasing the product 22 now being purchased, including a picture 50, a description 52, a Unit Price 54, a Quantity control 56, an Update control 58 for when the quantity is changed with the Quantity control 56, and an extended Cost 60. The purchase information further includes a Subtotal cost 62 and a Total cost 64.

The salient difference between browser screen 16 as shown in FIGS. 3 and 4 is the lower amount shown in the Unit Price 54 in FIG. 4, which, in turn, effects the amounts shown in the extended Cost 60, the Subtotal cost 62, and the Total cost 64.

Returning to FIG. 2, the data present in the price match dialog form 36 there serves for a set of examples. For the sake of a first such example, let us say that the data is correct (i.e., that BetaStores.com, as entered in the competitor entry control 46, is advertising and selling the subject product 22 for $18.95 each, as shown in the price entry control 42), and further that Beta Stores is not engaged in any relevant unfair business practices.

This example is anticipated to be the most typical scenario that the inventive price matching system 10 will encounter. Once the user in this example engages the Add To Cart control 32 in the browser screen 14 they are taken to the browser screen 16 as shown in FIG. 4, where the amount in the price entry control 42 now appears as the Unit Price 54 (rather than the offer price 28 in the browser screen 12 in FIG. 1). And accordingly, the $18.95 Unit Price 54 properly is carried through into the extended Cost 60, the Subtotal cost 62, and the Total cost 64.

As a second example, let us say that the data the user has entered into the price match dialog form 36 in FIG. 2 is incorrect. For instance, lets say that $20.95 is now the price that the product 22 is being advertised and sold for at the BetaStores.com website. Embodiments of the price matching system 10 can be configured to handle this in different ways. An advisement can be presented to the user informing them that the price $18.95 is invalid, and the user then has the option of going back to the browser screen 12 in FIG. 1 and going ahead with a purchase based on the $21.37 offer price 28 there. Alternately, an advisement can be presented to the user informing them that the current price at BetaStores.com is $20.95, and then the user themselves can enter that amount into the price entry control 42 or the price matching system 10 can enter it there for the user to accept by then following the concluding instructions 48. Still alternately, the price matching system 10 can go ahead with the transaction. After all, the two parties are only 42¢ apart. In fact, the vendor may configure the price matching system 10 to simply accept any amount submitted in the price entry control 42, regardless of competitor details, just so long as this “counter offer” amount is within a preset margin of the offer price 28 for the particular product 22.

Now as a third example, let us say that the Beta Stores (our hypothetical competitor here) is engaged in the common but unfair business practice of under pricing products and over charging for shipping and/or handling. For instance, lets say that normal shipping for the product 22 here is $1.75, that the product 22 is advertised for $18.95 at BetaStores.com, and that Beta Stores is charging $8.00 for “Shipping & Handling.” Thus, buying the product 22 for our vendor's $21.37 offer price 28 plus normal shipping totals only $23.12, and buying the product 22 for Beta Stores' $18.95 price plus its inflated shipping and handling totals. $26.95, and matching Beta Stores' $18.95 price and charging only normal shipping totals merely $20.70.

If our vendor using the price matching system 10 were simply to ignore how shipping and handling is being abused here, and were to accept $20.70, they would unfairly lose $2.42 on the transaction. In deed, the user-customer here might full well know what Beta Stores is doing and them self be trying to exploit the situation. This is where embodiments of the inventive price matching system 10 that have the optional shipping entry control 44 and appropriate limitations stated in the restrictions 40 can make things right.

To deal with this situation, the user can be provided an advisement that, per our vendor's restrictions 40, the vendor will still go ahead with a transaction when a competitor applies abnormal shipping and/or handling charges, but that this will then be subject to matching of both of the competitor's costs. If the user-customer then wants to go ahead they can do so, by entering $8.00 in the shipping entry control 44 to match Beta Stores shipping and handling cost. Or the price matching system 10 can enter this there for them, with the user then having the option to accept it by engaging the Add To Cart control 32.

Of course, the user-customer here in this last example would be unwise to pay $18.95+$8.00=$26.95 when they could instead pay only $21.37+$1.75=$23.12. Rather than putting our vendor and the customer at odds, however, this approach clearly shows the user-customer that our vendor is willing to give them the very same deal they would get from Beta Stores.

It may not always be the case, however, that pricing oddities are unfair. Some situations will doubtless arise where the sum of a competitor's advertised product cost and its higher than normal shipping cost is still less than our vendor's offer and normal shipping costs. The inventive price matching system 10 then can flexibly permit vendors to deal with these situations. In fact a user customer here, say a regular customer, might even be aware of this situation and simply go ahead and enter the competitor's shipping cost into the shipping entry control 44 at the same time they enter its advertised product cost into the price entry control 42.

FIG. 5 is a flow chart showing a price matching process 100 in accord with the present invention. In a step 102 the process 100 starts. If desired, set-up operations can be performed here.

In a step 104 the user browses the e-commerce web site of a vendor using the price matching system 10, looking at various products. In a step 106 the user then selects the product 22 of interest to them, here typically one shown in a web page with other products. By selecting the product 22 (e.g., with a double mouse click or select and enter) in step 106, a step 108 follows where the browser screen 12 is displayed for the selected product 22.

In a step 110 the user is presented with a decision. They can accept the offer price 28 or they can operate the price match request control 34.

If the user accepts the offer price 28 in step 110, in a step 112 they are presented with another decision. They can back out or they can operate the Add To Cart control 32 to formally accept the product 22 at the offer price 28.

If the user backs out, they can return to step 106 to continue shopping (or they can exit the web site, or take various other actions that are not relevant here). Alternately, if the user does operate the Add To Cart control 32 in step 112, a step 114 follows where they proceed through a virtual checkout, and a step 116 follows where the process 100 is exited. Note, the inventor's presently preferred embodiment of the inventive price matching system 10 is used for close-out type merchandise, where the product 22 is typically an only item being purchased. In other embodiments, say, for other types of merchandise, it is a straightforward matter for step 114 to include sub-steps where the user can opt to check out or to return to shopping and potentially put more products 22 into their virtual shopping cart.

Returning now to step 110, if the user operates the price match request control 34, a step 118 follows where the browser screen 14 is presented, which particularly includes the price match dialog form 36. In a step 120 the user then enters data into the price match dialog form 36, including data in at least the price entry control 42 and the competitor entry control 46.

Next, in a step 122 the user makes another decision. They can return to (essentially continue with) step 120. Alternately, they can now operate the Add To Cart control 32 to submit a counter offer for the product 22 at the price they entered into the price entry control 42.

If the user operates the Add To Cart control 32, a step 124 follows. As alluded to in the examples discussed above, this step 124 can vary considerably in different embodiments of the inventive price matching system 10.

Without limitation, some variations of step 124 can include the following. The data in the price entry control 42 and the competitor entry control 46 can be validated. One very simple way to do this is to have a webbot (e.g., a Visual Basic™ or Java™ script-based sub-process that processes data in web pages) search the web page at the web address in the competitor entry control 46 for any value matching the data entered in the price entry control 42. If a match is found, this may be considered enough to proceed with the transaction (i.e., proceed to step 126, discussed presently). If a product 22 is relatively inexpensive, and perhaps additionally if there is frequent human review of transactions, this alone may be considered adequate.

Of course, there is the possibility that a web page entered into the competitor entry control 46 has prices for many items, or simply has lots of numerical values present. Then a user may deliberately or inadvertently enter a price that is wrong for the particular product 22 that they are attempting to purchase. To deal with this a more sophisticated webbot can be used. For instance, one that looks for data somewhat, closely, or exactly matching the description 26 of the product 22 in the same web page and in close proximity to the value corresponding with the data entered in the price entry control 42. This then may be adequate in many scenarios where the price matching system 10 is employed.

Alternately, a product 22 may be expensive or the vendor operating the price matching system 10 may simply feel it desirable to employ stronger “transaction security.” As part of step 124 the process 100 instead can compare the offer price 28 and the counter offer price (the user entered value in the price entry control 42) and determine if there is a suspicious difference, say, a difference exceeding a preset limit of 10%. Then a very sophisticated webbot can be employed, for instance, to examine the web page entered in the competitor entry control 46 in closer detail or to also examine two, five, ten, etc. other e-commerce web sites for the same product 22 and see what the pricing is there. Depending on the sophistication of the webbot and the configuration of the price matching system 10 by the vendor using it, an automated decision to proceed can here be made. Or an automated decision can be made to not proceed. This can be to not proceed at all, probably subject to some reservation stated in the restrictions 40, or to not proceed until there is human review of the pending transaction. If the vendor has a “clerk” available, without the user-customer even being made aware, there can be immediate review of the pending transaction, and optionally also of the webbot gathered data or with consultation made to other resources to determine why things are suspicious. Alternately, if a clerk is not currently available, the user-customer can automatically be informed that their business is valued but that a supervisor's approval is needed, and they can be politely requested to enter an e-mail address and to expect a reply within 24 hours.

Clearly, many other variations of step 124 are possible, probably too many to reasonably list here. The present invention is not limited to such variations. Rather, such variations are merely alternate component parts that can be employed and the spirit and scope of the present invention should accordingly be interpreted broadly.

Returning now to the process 100, after step 124 and presuming the transaction is found acceptable there, a step 126 follows where the browser screen 16 is presented to the user (see e.g., FIG. 4). Next, in essentially conventional manner for e-commerce processes, in a step 128 checkout occurs. And then, in step 116, the process 100 exits.

While various embodiments have been described above, it should be understood that they have been presented by way of example only, and that the breadth and scope of the invention should not be limited by any of the above described exemplary embodiments, but should instead be defined only in accordance with the following claims and their equivalents.

What is claimed is:

1. A computer program, embodied on a computer readable storage medium, for a customer to obtain price matching from a vendor in an ecommerce transaction, the computer program comprising:
a code segment that presents a first browser screen to the customer offering a product of the vendor, wherein said first browser screen includes:
information about the product that further includes an offer price; and
a price match request control that the customer may selectively operate;
a code segment that presents a second browser screen responsive to operation of said price match request control, wherein said second browser screen includes:
a price match dialog form that further includes a price entry control for the customer to enter counter price data and a competitor entry control for the customer to enter competing vendor data; and
a web site navigation control that the customer may selectively operate;
a code segment that, responsive to said web site navigation control,
performs an analysis of said counter price data and said competing vendor data to determine acceptability of the ecommerce transaction, and
presents a third browser screen that includes an unit price that displays said counter price data entered by the customer if the vendor is accepting the ecommerce transaction.

2. The computer program of claim 1, wherein:
said second browser screen further includes a shipping entry control for the customer to enter counter shipping data; and
said third browser screen further includes a total price that displays a value based on said unit price and counter shipping data if the vendor is accepting the ecommerce transaction.

3. The computer program of claim 1, wherein said web site navigation control is an add to cart control.

4. The computer program of claim 1, wherein said analysis includes determining if any difference between said offer price and said counter price data is within a preset range.

5. The computer program of claim 1, wherein said analysis includes authenticating said competing vendor data.

6. The computer program of claim 1, wherein said analysis includes validating said offer price against said competing vendor data.

7. A method for a customer to obtain price matching from a vendor in an ecommerce transaction, the method comprising:
presenting a first browser screen to the customer offering a product of the vendor, wherein said first browser screen includes:
information about the product that further includes an offer price; and
a price match request control that the customer may selectively operate;
monitoring for operation of said price match request control and, responsive there to, presenting a second browser screen, wherein said second browser screen includes:
a price match dialog form that further includes a price entry control for the customer to enter counter price data and a competitor entry control for the customer to enter competing vendor data; and
a web site navigation control that the customer may selectively operate;
responding to operation of said web site navigation control by:
analyzing said counter price data and said competing vendor data for acceptability of the ecommerce transaction; and
if the vendor is accepting the ecommerce transaction, presenting a third browser screen that includes an unit price that displays said counter price data entered by the customer.

8. The method of claim 7, wherein said second browser screen further includes a shipping entry control for the customer to enter counter shipping data and the method further comprising:
if the vendor is accepting the ecommerce transaction, displaying in said third browser screen a total price having a value based on said unit price and counter shipping data.

9. The method of claim 7, wherein said analyzing includes determining if any difference between said offer price and said counter price data is within a preset range.

10. The method of claim 7, wherein said analyzing includes authenticating said competing vendor data.

11. The method of claim 7, wherein said analyzing includes validating said offer price against said competing vendor data.

12. A system for a customer to obtain price matching from a vendor in an ecommerce transaction, the system comprising:
means for presenting a first browser screen to the customer offering a product of the vendor, wherein said first browser screen includes information about the product, which further includes an offer price, and a price match request control that the customer may selectively operate;
means for monitoring for operation of said price match request control;
means for presenting a second browser screen that includes a price match dialog form, which further includes a price entry control for the customer to enter counter price data and a competitor entry control for the customer to enter competing vendor data;
means for analyzing said counter price data and said competing vendor data for acceptability of the ecommerce transaction; and
means for presenting a third browser screen that includes an unit price having said counter price data entered by the customer if the vendor accepts the ecommerce transaction.

13. The system of claim 12, wherein said second browser screen further includes a web site navigation control that the customer may selectively operate and the system method further comprising:
means for detecting operation of said web site navigation control and imitating operation of said means for analyzing.

14. The system of claim 13, wherein said web site navigation control is an add to cart control.

15. The system of claim 12, wherein said second browser screen further includes a shipping entry control for the customer to enter counter shipping data and the system method further comprising:
means for displaying in said third browser screen a total price having a value based on said unit price and counter shipping data if the vendor accepts the ecommerce transaction.

16. The system of claim 12, wherein said second browser screen further includes a shipping entry control for the customer to enter counter shipping data and the system method further comprising:
means for displaying in said third browser screen a total price having a value based on said unit price and counter shipping data if the vendor accepts the ecommerce transaction.

17. The system of claim 12, wherein said means for analyzing is further for determining if any difference between said offer price and said counter price data is within a preset range.

18. The system of claim 12, wherein said means for analyzing is further for authenticating said competing vendor data.

19. The system of claim 12, wherein said means for analyzing is further for validating said offer price against said competing vendor data.
